(19) United States
(12) Patent Application Publication
(10) Pub. No.: US 2026/0141267 A1
(43) Pub. Date: May 21, 2026

(54) SYSTEM AND METHOD FOR PERFORMING LINK PREDICTION IN KNOWLEDGE GRAPH USING TOPOLOGICAL INFORMATION IN LARGE LANGUAGE MODELS

(71) Applicant: JPMorgan Chase Bank, N.A., New York, NY (US)

(72) Inventors: Udari Madhushani SEHWAG, Jersey City, NJ (US); Kassiani PAPASOTIRIOU, New York, NY (US); Jared VANN, London (GB); Sumitra GANESH, Short Hills, NJ (US)

(73) Assignee: JPMorgan Chase Bank, N.A., New York, NY (US)

(21) Appl. No.: 18/966,853

(22) Filed: Dec. 3, 2024

(30) Foreign Application Priority Data
Nov. 21, 2024 (GR) 20240100830

(51) Int. Cl. G06N 5/025

(52) U.S. Cl. CPC G06N 5/025

(57) ABSTRACT

Various methods and processes, apparatuses or systems, and media for performing a link prediction of a missing node in a knowledge graph are disclosed. The present disclosure provides acquiring the knowledge graph and extracting a set of information from the knowledge graph, the set of information indicates data entities and edges. Each of the edges indicates a relationship between a pair of data entities. The method further includes identifying triplets included in the knowledge graph, in which each of the triplets includes a pair of nodes connected by an edge, and generating an ontological graph model based on the triplets identified and the acquired knowledge graph. The method further performs, via the LLM, a link prediction for the missing node of the knowledge graph based on the generated ontological graph model.

### CROSS-REFERENCE TO RELATED APPLICATION

This application claims the benefit of Greek Patent Application No. 20240100830, filed November 21, 2024, which is hereby incorporated by reference in its entirety.

### TECHNICAL FIELD

This disclosure generally relates to performing a link prediction for completing a knowledge graph by leveraging large language models to topological information.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Knowledge graphs are tools for representing and reasoning over structured information. Such graphs may support various applications, such as information retrieval, question answering and decision making. However, knowledge graphs are often incomplete, which limits their effectiveness in real-world scenarios. Such incompleteness may be a result of challenges involved in constructing and maintaining comprehensive knowledge graphs, which may typically require significant manual effort and domain expertise.

Although various efforts for providing knowledge graph completion (KGC) have been expanded, conventional approaches still face limitations. Current approaches often struggle to fully leverage recent advancements in artificial intelligence, particularly in large language models (LLMs). Although these models have demonstrated impressive capabilities in understanding and generating human-like text, their potential for enhancing knowledge graph completion tasks remains largely untapped.

### SUMMARY

The present disclosure, through one or more of its various aspects, embodiments, and/or specific features or sub-components, provides, among other features, a method for performing a link prediction of a missing node in a knowledge graph using a large language model (LLM) without prior training for the knowledge graph is provided. The method includes acquiring, by a processor and over a communication network, the knowledge graph; extracting, by the processor, a set of information from the knowledge graph, wherein the set of information indicates a plurality of data entities, a plurality of relationships, and attributes for one or more of the plurality of data entities, wherein each of the plurality of relationships indicates a relationship between a pair of data entities among the plurality of data entities, and wherein each of the data entities corresponds to a node on the knowledge graph; identifying, by the processor, a plurality of triplets included in the knowledge graph based on the extracted set of information, wherein each of the plurality of triplets includes a pair of nodes connected by a relationship, and wherein the plurality of triplets includes at least one triplet with a missing node; generating, by the processor, an ontological graph model based on the plurality of triplets identified and the acquired knowledge graph, wherein the ontological graph model includes a plurality of triplets, wherein each of the plurality of triplets includes a pair of nodes connected by a relationship, wherein each of the nodes corresponds to a category of a data entity; and performing, via the LLM, a link prediction for the missing node of the knowledge graph based on the generated ontological graph model.

In some embodiments, the pair of nodes of the ontological graph model includes a head node from which the relationship flows from and a tail node to which the relationship is directed to.

In some embodiments, the missing node of knowledge graph corresponds to the tail node of the ontological graph model.

In some embodiments, the generating of the ontological graph model includes: identifying, by the processor, the plurality of relationships included in the knowledge graph; for each of the plurality of relationships identified, identifying, by the processor, a pair of nodes of the knowledge graph connected by a corresponding relationship, the pair of nodes of the knowledge graph and the corresponding relationship forming a triplet among the plurality of triplets; for each of the pair of nodes of the knowledge graph, identifying, by the processor, a head node and a tail node; predicting, by applying a machine learning model executed by the processor, a category for the head node of the knowledge graph and a category of the tail node of the knowledge graph based on a corresponding relationship among the plurality of relationships; generating a portion of the ontological graph model by forming a target triplet including the category for the head node of the knowledge graph and the category of the tail node of the knowledge graph connected by the corresponding relationship; and building, by the processor, the ontological graph model by using the target triplet.

In some embodiments, the ontological graph model is formed of the plurality of triplets including the target triplet including the category for the head node of the knowledge graph and the category of the tail node of the knowledge graph connected by the corresponding relationship.

In some embodiments, the head node of the target triplet forms a tail node in another triplet in the ontological graph model.

In some embodiments, the generating of the ontological graph model further includes: feeding the generated portion of the ontological graph model to the machine learning model for performing a prediction of categories for another triplet that is to be added to the ontological graph model.

In some embodiments, the link prediction is performed using a topology of the ontological graph model, and the link prediction using the topology of the ontological graph model includes: identifying, by the processor, an incomplete triplet including a missing head/tail node from the knowledge graph; inferring, via the machine learning model, a category of the missing head/tail node using the generated ontological graph model and based on a relationship included in the incomplete triplet and a category of a head node included in the incomplete triplet; providing, to the LLM, the inferred category of the missing head/tail node; computing, by the processor, alternative ontological graph model paths from the head node of the incomplete triplet to the missing head/tail node of the incomplete triplet; providing, to the LLM, the computed alternative ontological graph model paths as contextual information; and performing, by the LLM, the link prediction based on the contextual information.

In some embodiments, at least one of the alternative ontological graph model paths includes at least two triplets that are connected.

In some embodiments, the link prediction is performed using candidate solutions, and the link prediction using the candidate solutions includes: identifying, by the processor, an incomplete triplet including a missing head/tail node from the knowledge graph; inferring, via the machine learning model, a category of the missing head/tail node using the generated ontological graph model and based on the relationship included in the incomplete triplet and a category of a head node included in the incomplete triplet; identifying, via the machine learning model, candidate nodes that match the inferred category of the missing head/tail node based on dataset of the knowledge graph; and prompting, the LLM, with a list of the candidate nodes as a hint for predicting the missing head/tail node.

In some embodiments, the link prediction using the candidate solutions further includes: splitting, by the processor, the list of the candidate nodes into a plurality of sublists; performing a plurality of LLM calls to the LLM with the plurality of sublists; collecting, by the processor, a top candidate from each of the plurality of sublists based on the plurality of LLM calls; and performing a subsequent LLM call to the LLM with the collected top candidates to predict a single solution for the missing head/tail node among the collected top candidates.

In some embodiments, the link prediction is performed using a chain-of-thought (CoT) reasoning, and the link prediction using the CoT reasoning includes: identifying, by the processor, an incomplete triplet including a missing head/tail node from the knowledge graph; inferring, via the machine learning model, a category of the missing head/tail node using the generated ontological graph model and based on the relationship included in the incomplete triplet and a category of a head node included in the incomplete triplet; providing the LLM with a series of intermediate reasoning steps included in the ontological graph model and knowledge graph structure; generating a plurality of prompts that guide the LLM to perform a step-by-step reasoning to derive a solution for the missing head/tail node; incorporating a plurality of ontological graph model paths and a plurality of knowledge graph paths to the identified missing head/tail node to provide contextual information; informing the LLM of the inferred category of the missing head/tail node; generating and feeding a series of prompts, based on the contextual information and the inferred category of the missing node, to cause the LLM to make logical connections between nodes included in the ontological graph model and the knowledge graph, and the missing head/tail node and the inferred category of the missing head/tail node; and generating, by the LLM, a solution for the missing head/tail node based on the series of prompts.

In some embodiments, the link prediction is a transductive link prediction that predicts a relationship among known entities within the knowledge graph.

In some embodiments, the link prediction is an inductive link prediction that predicts a relationship of a new entity with respect to known entities within the knowledge graph.

In some embodiments, the relationships in the knowledge graph are same as the relationships in the ontological graph model.

In some embodiments, the ontological graph model includes a plurality of paths from a head node to a tail node of a respective triplet.

In some embodiments, the LLM is automatically prompted based on the plurality of paths and structural information of the knowledge graph.

In some embodiments, a system for performing a link prediction of a missing node in a knowledge graph using a large language model (LLM) without prior training for the knowledge graph is disclosed. The system may include: a processor configured to execute one or more applications; and a memory operatively connected to the processor via a communication interface, the memory storing computer readable instructions, when executed, causes the processor to: acquiring, over a communication network, the knowledge graph; extracting a set of information from the knowledge graph, wherein the set of information indicates a plurality of data entities, a plurality of relationships, and attributes for one or more of the plurality of data entities, wherein each of the plurality of relationships indicates a relationship between a pair of data entities among the plurality of data entities, and wherein each of the data entities corresponds to a node on the knowledge graph; identifying a plurality of triplets included in the knowledge graph based on the extracted set of information, wherein each of the plurality of triplets includes a pair of nodes connected by a relationship, and wherein the plurality of triplets includes at least one triplet with a missing node; generating an ontological graph model based on the plurality of triplets identified and the acquired knowledge graph, wherein the ontological graph model includes a plurality of triplets, wherein each of the plurality of triplets includes a pair of nodes connected by a relationship, wherein each of the nodes corresponds to a category of a data entity; and performing, via the LLM, a link prediction for the missing node of the knowledge graph based on the generated ontological graph model.

In some embodiments, a non-transitory computer readable medium configured to store instructions for performing a link prediction of a missing node in a knowledge graph using a large language model (LLM) without prior training for the knowledge graph is disclosed. The instructions, when executed, may cause a processor to perform the following: acquiring, over a communication network, the knowledge graph; extracting a set of information from the knowledge graph, wherein the set of information indicates a plurality of data entities, a plurality of relationships, and attributes for one or more of the plurality of data entities, wherein each of the plurality of relationships indicates a relationship between a pair of data entities among the plurality of data entities, and wherein each of the data entities corresponds to a node on the knowledge graph; identifying a plurality of triplets included in the knowledge graph based on the extracted set of information, wherein each of the plurality of triplets includes a pair of nodes connected by a relationship, and wherein the plurality of triplets includes at least one triplet with a missing node; generating an ontological graph model based on the plurality of triplets identified and the acquired knowledge graph, wherein the ontological graph model includes a plurality of triplets, wherein each of the plurality of triplets includes a pair of nodes connected by a relationship, wherein each of the nodes corresponds to a category of a data entity; and performing, via the LLM, a link prediction for the missing node of the knowledge graph based on the generated ontological graph model.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a link prediction large language model (LPLLM) in accordance with an embodiment.

FIG. 2 illustrates a diagram of a network environment for implementing an LPLLM system in accordance with an embodiment.

FIG. 3 illustrates a system configuration diagram for implementing an LPLLM system in accordance with an embodiment.

FIG. 4 illustrates a method for performing a link prediction by feeding knowledge graph into a large language model (LLM) in accordance with an embodiment.

FIG. 5 illustrates a knowledge graph.

FIG. 6 illustrates an ontological graph model generated based on one or more knowledge graphs in accordance with an embodiment.

FIG. 7 illustrates a method for generating an ontological graph model using a knowledge graph using an LPLLM system in accordance with an embodiment.

FIG. 8 illustrates a method for performing a link prediction using topology of a generated ontological graph model in accordance with an embodiment.

FIG. 9 illustrates a method for performing a link prediction using candidate solutions in accordance with an embodiment.

FIG. 10 illustrates a link prediction performed by an LPLLM system on an incomplete knowledge graph in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

According to some aspects, present disclosure allows large language models (LLMs) to be leveraged to knowledge graphs for completion of incomplete knowledge graphs, and to further enhance knowledge graphs with additionally inferred links or relationships, leading to a more robust knowledge graph that is capable of providing additional information that were previously unavailable. Moreover, by leveraging existing knowledge graphs and/or other information as inputs, LLMs may be configured to generate prompts for obtaining new information without initially requiring training of LLMs for such prompting. Accordingly, existing LLMs may be leveraged for new set of information that the LLMs have not encountered without prior training, which allows for dynamic or impromptu configuration of LLMs that were conventionally unavailable. Such dynamic or impromptu configuration of LLMs may lead to savings in computational resources that were conventionally expanded for training of LLMs. Lastly, based on the prompting of the dynamically configured LLMs, insights into the LLM’s decision making-process for performing a prediction may be provided.

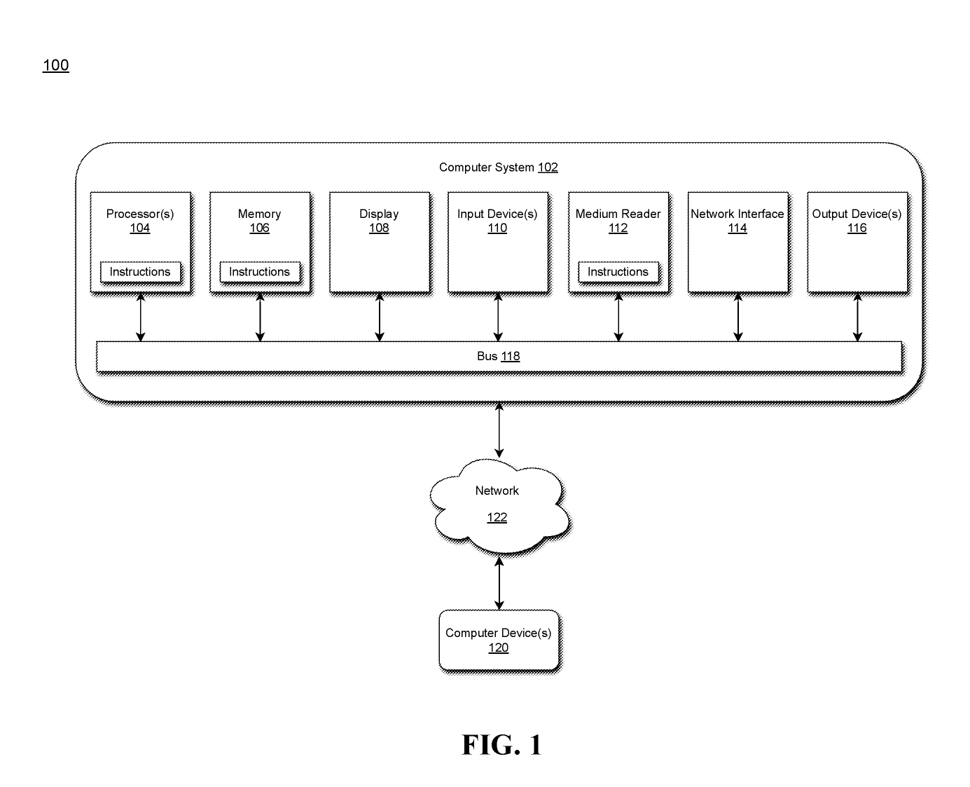

FIG. 1 is a system 100 for use in implementing a link prediction large language model (LPLLM) system in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are mere examples and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are not meant to be exhaustive and/or inclusive.

In some embodiments, the link prediction large language model (LPLLM) module implemented by the system 100 may allow for an LPLM module to perform a link prediction of a missing node in a knowledge graph using an LLM without prior training for the respective knowledge graph. Further, the disclosed LPLLM module allows for generation of an ontological graph model for a corresponding knowledge graph, and feeding the ontological graph model to the LLM for performing a link prediction on the knowledge graph without prior training of the LLM.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

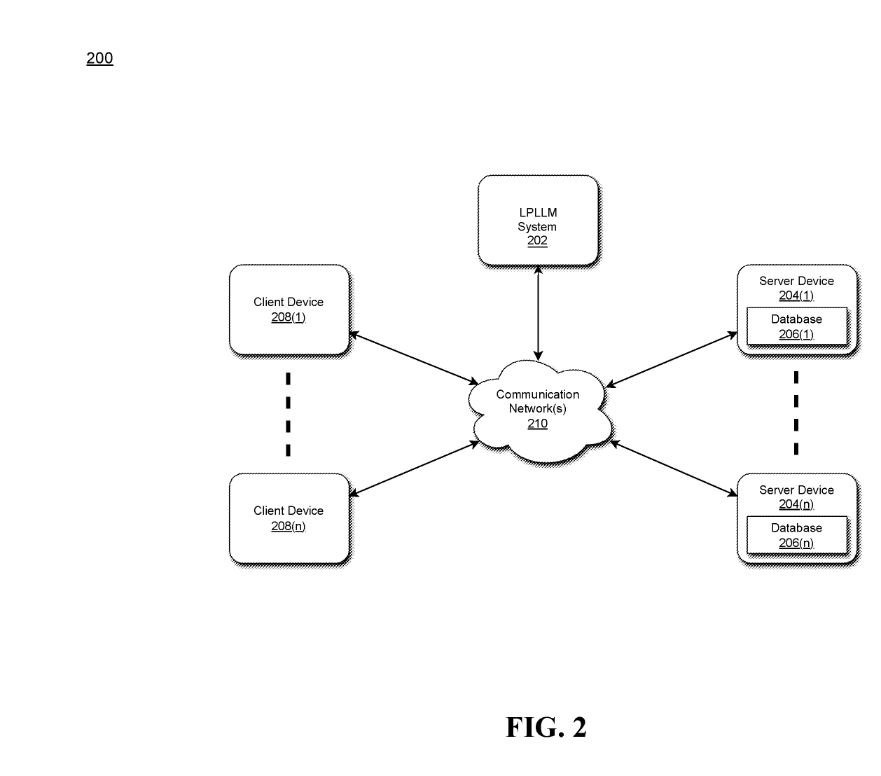

Referring to FIG. 2, a schematic of a network environment 200 for implementing an LPLLM is illustrated.

In some embodiments, the above-described problems associated with conventional knowledge graph completion tools may be overcome by implementing an LPLLM system 202 as illustrated in FIG. 2 that may be configured for implementing an LPLLM module configured for generating an ontological graph model based on a knowledge graph, and applying the generated ontological graph model to the LLM for performing a link prediction for the missing information in the knowledge graph for performance of the knowledge graph completion.

The LPLLM system 202 may include one or more computer system 102s, as described with respect to FIG. 1, which in aggregate provide the necessary functions.

The LPLLM system 202 may store one or more applications that can include executable instructions that, when executed by the LPLLM system 202, cause the LPLLM system 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the LPLLM system 202 itself, may be located in virtual server(s) running in a cloud-based computing environment rather than being tied to one or more specific physical network computing devices. Also, the application(s) may be running in one or more virtual machines (VMs) executing on the LPLLM system 202. Additionally, in one or more embodiments of this technology, virtual machine(s) running on the LPLLM system 202 may be managed or supervised by a hypervisor.

In the network environment 200 of FIG. 2, the LPLLM system 202 may be coupled to a plurality of server devices 204(1)-204(n) that hosts a plurality of databases 206(1)-206(n), and also to a plurality of client devices 208(1)-208(n) via communication network(s) 210. A communication interface of the LPLLM system 202, such as the network interface 114 of the computer system 102 of FIG. 1, operatively couples and communicates between the LPLLM system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the LPLLM system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The LPLLM system 202 may be a standalone device or integrated with one or more other devices or apparatuses, such as one or more of the server devices 204(1)-204(n), for example. In one particular example, the LPLLM system 202 may be hosted by one of the server devices 204(1)-204(n), and other arrangements are also possible. Moreover, one or more of the devices of the LPLLM system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the LPLLM system 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the LPLLM system 202 that may efficiently provide an LPLLM module configured for generating an ontological graph model based on a knowledge graph and performing a link prediction for a missing node of the knowledge graph by applying the ontological graph model to an LLM, but the disclosure is not limited thereto.

The client devices 208(1)-208(n) may run interface applications, such as standard web browsers or standalone client applications, which may provide an interface to communicate with the LPLLM system 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the LPLLM system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are examples, as many variations of the specific hardware and software used to implement the examples are possible, as may be appreciated by those skilled in the relevant art(s).

One or more of the devices depicted in the network environment 200, such as the LPLLM system 202, the server devices 204(1)-204(n), or the client devices 208(1)-208(n), for example, may be configured to operate as virtual instances on the same physical machine. For example, one or more of the LPLLM system 202, the server devices 204(1)-204(n), or the client devices 208(1)-208(n) may operate on the same physical device rather than as separate devices communicating through communication network(s) 210. Additionally, there may be more or fewer LPLLM system s 202, server devices 204(1)-204(n), or client devices 208(1)-208(n) than illustrated in FIG. 2. In some embodiments, the LPLLM system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

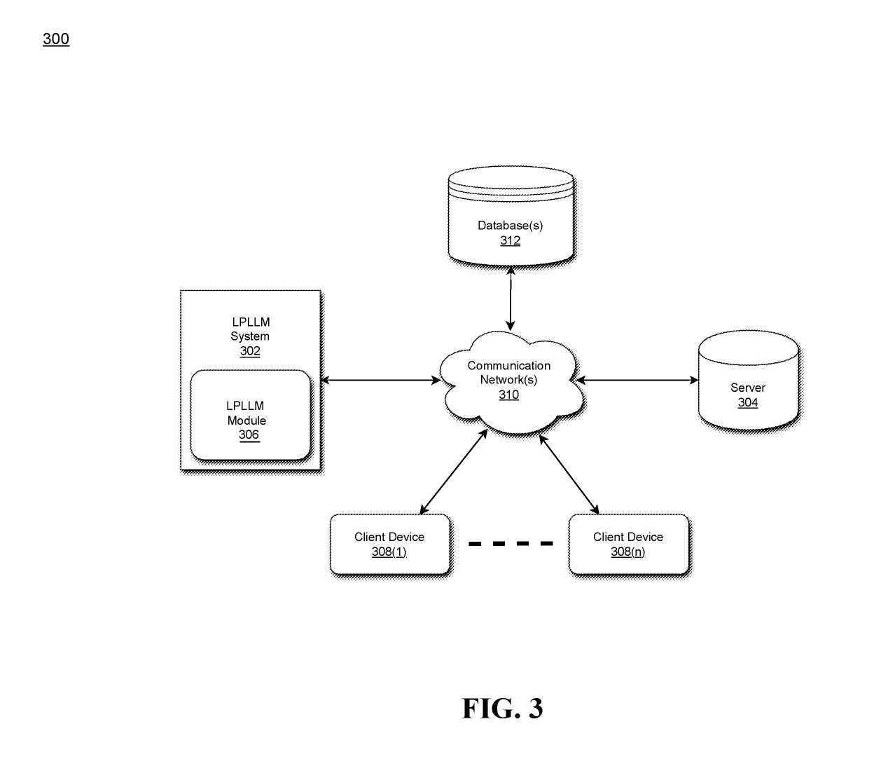

FIG. 3 illustrates a system diagram for implementing an LPLLM system in accordance with an embodiment.

As illustrated in FIG. 3, the system 300 may include an LPLLM system 302 within which an LPLLM module 306 is embedded, a server 304, a database(s) 312, a plurality of client devices 308(1) … 308(n), and a communication network 310.

In some embodiments, the LPLLM system 302 including the LPLLM module 306 may be connected to the server 304, and the database(s) 312 via the communication network 310. The LPLLM system 302 may also be connected to the plurality of client devices 308(1) … 308(n) via the communication network 310, but the disclosure is not limited thereto. The database(s) 312 may include one or more rule databases.

In an embodiment, the LPLLM system 302 is described and shown in FIG. 3 as including the LPLLM module 306, although it may include other rules, policies, modules, databases, or applications, for example. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the LPLLM module 306 may be configured to receive real-time feed of data from the plurality of client devices 308(1) … 308(n) and secondary sources via the communication network 310.

The LPLLM module 306 may be configured to: acquire, over a communication network, the knowledge graph; extract a set of information from the knowledge graph, in which the set of information indicates a plurality of data entities, a plurality of relationships, and attributes for one or more of the plurality of data entities, in which each of the plurality of relationships indicates a relationship between a pair of data entities among the plurality of data entities, and in which each of the data entities corresponds to a node on the knowledge graph; identify a plurality of triplets included in the knowledge graph based on the extracted set of information, in which each of the plurality of triplets includes a pair of nodes connected by a relationship, and in which the plurality of triplets includes at least one triplet with a missing node; generate an ontological graph model based on the plurality of triplets identified and the acquired knowledge graph, in which the ontological graph model includes a plurality of triplets, in which each of the plurality of triples includes a pair of nodes connected by a relationship, in which each of the nodes corresponds to a category of a data entity; and perform, via the LLM, a link prediction for the missing node of the knowledge graph based on the generated ontological graph model, but the disclosure is not limited thereto.

The plurality of client devices 308(1) … 308(n) are illustrated as being in communication with the LPLLM system 302. In this regard, the plurality of client devices 308(1) … 308(n) may be “clients” (e.g., customers) of the LPLLM system 302 and are described herein as such. Nevertheless, it is to be known and understood that the plurality of client devices 308(1) … 308(n) need not necessarily be “clients” of the LPLLM system 302, or any entity described in association therewith herein. Any additional or alternative relationship may exist between either or both of the plurality of client devices 308(1) … 308(n) and the LPLLM system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) … 308(n) may communicate with the LPLLM system 302 via broadband or cellular communication. Of course, these embodiments are merely examples and are not limiting or exhaustive.

The computing device 301 may be the same or similar to any one of the client devices 208(1)-208(n) as described with respect to FIG. 2, including any features or combination of features described with respect thereto. The LPLLM system 302 may be the same or similar to the LPLLM system 202 as described with respect to FIG. 2, including any features or combination of features described with respect thereto.

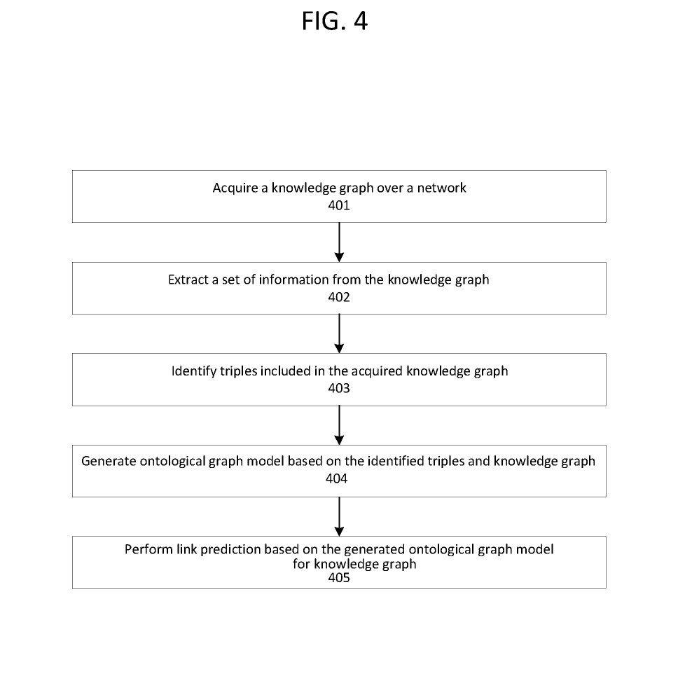

FIG. 4 illustrates a method for performing a link prediction by feeding knowledge graph into a LLM in accordance with an embodiment.

According to some aspects, two-part process for completion of a knowledge graph is provided. First part involves a construction of an ontological graph model from a knowledge graph using an LLM’s domain understanding, by capturing types of nodes and relationships in the knowledge graph. By combining the constructed ontological structure with the knowledge graph’s topology and utilizing one or more prediction methods (e.g., chain of though (CoT) style reasoning, candidate solution, topology of ontological graph model and the like), LLM may be configured or provided with context to make better informed predictions to provide an LPLLM. Second part involves leveraging structured information from the knowledge graph, by utilizing overlapping nodes between the missing knowledge triplets or triples and the existing graph triplets or triples, combining with the ontological graph model to generate candidate solutions for the missing information. Further, by considering alternative paths between the existing nodes and potential candidate nodes, complex topological structure of the graph may be exploited.

More specifically, aspects of the present disclosure are directed to a method for creating a generative ontological graph model using a machine learning model, including LLMs, for deriving ontologies from raw knowledge graph or other topological data, capturing types of nodes and relationships in the knowledge graph or other topological data. Aspects of the present disclosure are further directed to leveraging the generated ontological graph model and the knowledge graph’s information, including paths between nodes, for enhancing link prediction. Further, by utilizing the ontological graph model to identify candidate solutions for the missing triplets or triples and employing the LLM to select the correction solution, knowledge graph competition performance may be significantly improved. In addition, the disclosed method requires no additional training, allowing for immediate applicability.

In operation 401, a knowledge graph is acquired over a network. According to some aspects, the one or more knowledge graphs may be generated in advance and stored on a database for retrieval. However, aspects of the present disclosure are not limited thereto, such that at least one of the knowledge graphs may be generated in real-time. In an example, the knowledge graphs may be incomplete. Further, not all portions of the knowledge graph may come with ontological graph model.

According to some aspects, knowledge graphs may represent structured information, and may have wide ranging applications, including information retrieval, question answering, decision making and the like. Knowledge graph may refer to a collection of interlinked data entities.

In operation 402, a set of information from the acquired knowledge graph may be extracted. According to some aspects, the set of information of the knowledge graph may include entities, relationships, and attributes. However, aspects of the present disclosure are not limited thereto, additional components may be included.

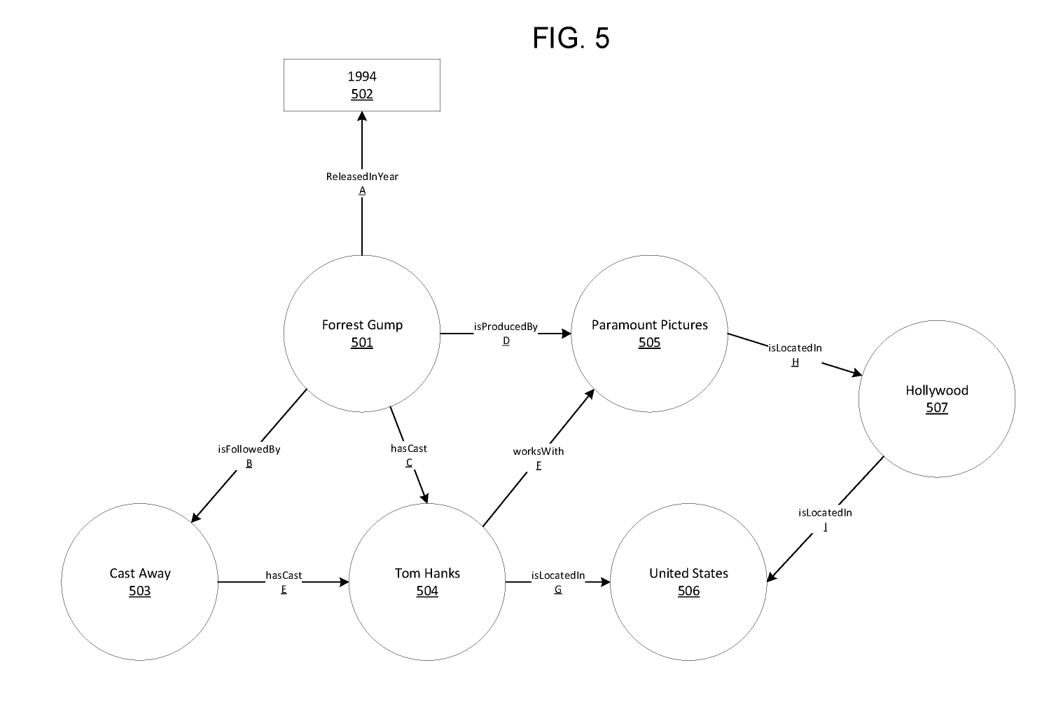

Entities may refer to specific data values stored in a database (e.g., “Tom Hanks”, “Forrest Gump”, “Cast Away” and the like). In some examples, each of the entities may correspond to a data node on a knowledge graph as illustrated in FIG. 5. The relationships or edges indicate a connection between the entities or data nodes on the knowledge graph. For example, a relationship, shown as an edge, may indicate a movie and an actor. Referring to FIG. 5, “Forrest Gump” may indicate having a cast of “Tom Hanks”, as exemplarily illustrated by node 501, node 504 and relationship or edge C. Attributes may include one or more properties describing an entity, such as production date or location. For example, attributes may indicate a production year for a movie.

Each of the data entities may be represented by a node, and each pair of nodes may have a relationship (represented via an edge) with each other as well as direction of data flow. The pair of nodes and the relationship between the nodes may be referred to as a triple. Accordingly, a knowledge graph may include multiples of such triples. A data node may serve as a head node or a tail node, depending on the triple. The head node may refer to a node from which the relationship or directional arrow originates from, and the tail node may refer to a node towards which the relationship or the directional arrow is directed. For example, node 505 may be a tail node in a triplet or a triple including nodes 504 and 505 connected by relationship F. However, node 505 may be a head node in a triplet including nodes 505 and 507 connected by relationship H.

In operation 403, triplets included in the acquired knowledge graph are identified. As the knowledge graphs are generated based on acquired data, each of the nodes in the knowledge graphs may represent or correspond to a specific data entity, such as an author name, a specific car model, a specific city and the like. In an example, the knowledge graphs may be complete in portions while incomplete in others. In other words, a knowledge graph may include a triple, where one of the data entity or data node is an unknown value, which may be referred to as a missing node. More specifically, the respective knowledge graph may include one node and an edge indicating a relationship. However, as triples are formed in knowledge graphs, it is understood that there has to be another node, but for which a value is unknown or unavailable. For example, the incomplete triplet may include a node indicating “Miles Davis” with a relationship of “born in”, but the node corresponding to the birthplace of Miles Davis may be an empty node. FIG. 5 illustrates a knowledge graph indicating various entities and relationship therebetween.

According to further aspects, a knowledge graph may include entities, relationships, and attributes. Entities may refer to specific instances of information or specific values included in data (e.g., “Forrest Gump” and “Tom Hanks” in FIG. 5). According to some aspects, entities may correspond to the nodes in the knowledge graph as exemplarily illustrated in FIG. 5. Relationships may indicate a connection between the individual entities. For example, a relationship may indicate “Forrest Gump” has a cast of “Tom Hanks”, as exemplarily illustrated by node 501, node 504 and relationship C in FIG. 5. Attributes may include one or more properties, such as a direction of relationship, describing an entity. For example, attributes may indicate that the relationship between the node 501 and node 504 flows from the node 501 to 504 (e.g., “Forrest Gump” → has cast → “Tom Hanks”).

More specifically, as exemplarily illustrated in FIG. 5, knowledge graphs may include multiple nodes with intervening arrows, which may indicate a relationship between the respective nodes as well as direction. As illustrated in FIG. 5, node 504 (indicating “Tom Hanks”) and node 506 (indicating “United States”) may be connected by relationship G (indicating “isLocatedIn”. The relationship G has a directionality element, which indicates a direction flowing from node 504 to node 506. These two nodes and intervening relationship may be a triple, and respectively indicates that Tom Hanks is located in United States. Similarly, node 504 (indicating “Tom Hanks”) and node 505 (indicating “Paramount Pictures”) connected by relationship F (indicating “worksWith”) may comprise another triple, which respectively indicates that Tom Hanks works with Paramount Pictures based on the directionality element of the relationship F.

Node 505 (indicating “Paramount Pictures”) also forms a triplet with node 507 (indicating “Hollywood”) with an intervening relationship H (indicating “isLocatedIn”). Although both the relationship 505 and 507 both indicates “isLocatedIn”, the first triplet references a country (i.e., United States), whereas third triplet references a city (i.e., Hollywood).

In operation 404, based on the one or more knowledge graphs acquired, an ontological graph model may be generated. According to some aspects, an LLM may be leveraged to generate an ontological graph model on top of a knowledge graph. Further, the generated ontological graph model or topological information of the ontological graph model may be provided to the LLM to predict missing head or tail nodes. The ontological graph model may formed of various nodes representing data concepts or classes, and edges that represent relationships between the various nodes.

According to some aspects, for generating an ontological graph model, for each unique relationship identified in the knowledge graph, one or more triplets connected by the respective relationships may be found. For example, for each unique relationship, a corresponding head node and a corresponding tail node may be gathered. Then each of the triples may be provided to the LLM to generalize or find a data entity type that would describe all of the head nodes corresponding to the unique relationship. Same operation may be also performed for all of the tail nodes corresponding to the unique relationship. For example, for the triple of Kassie → lives in → New York, and another triple of Udari → lives in → San Francisco, the LLM may predict that the head nodes connected to the relationship of “lives in” should be a type of person, and the tail nodes connected to the same relationship should be a type of city. Moreover, as the LLM processes through each of the unique triplets for building or expanding the ontological graph model, the LLM may be given an option to re-use some of the node categories that was identified previously.

According to some aspects, ontologies are generalized data models, which model types or categories of specific data values based on shared properties. Further, unlike knowledge graphs, ontologies do not include information about specific values (e.g., specific movies, actors, cities and the like). Ontologies may include classes (C), relationships (R) and attributes (Ɛ).

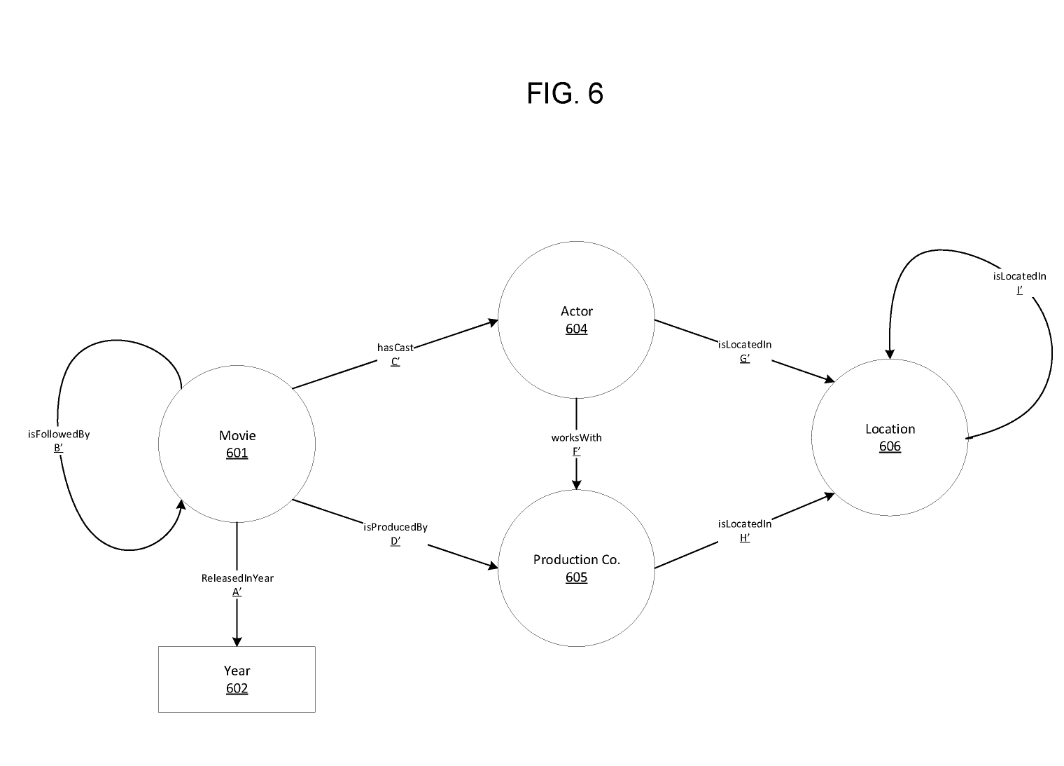

Classes (e.g., movies, actors, production co., and locations in FIG. 6) may refer to types or categories corresponding to the underlying data included in the knowledge graphs. According to some aspects, classes may correspond to the nodes in an ontological graph model as exemplarily illustrated in FIG. 6. Relationships may indicate a connection between the classes. For example, a relationship may indicate “Movie” has a cast “Actor”, as exemplarily illustrated by node 601, node 603 and relationship C. Attributes may include one or more properties, such as a direction of relationship, describing a class. For example, attributes may indicate that the relationship between the node 601 and node 603 flows from the node 601 to 603 (e.g., Movie → has cast → Actor).

More specifically, unlike knowledge graphs, where each of the nodes include specific data values, nodes of an ontological graph model may correspond to a category for such specific data values. For example, node 501 in FIG. 5 (indicating “Forrest Gump”) illustrating a knowledge graph may correspond to node 601 in FIG. 6, which indicates a “Movie” category. Similarly, node 503 in FIG. 5 (indicating “Cast Away”) may also correspond to node 601 in FIG. 6 indicating the “Movie” category.

In addition, node 504 in FIG. 5 (indicating “Tom Hanks”) may correspond to node 604 in FIG. 6 indicating an “Actor” category. Accordingly, one or more nodes of the knowledge graph may correspond to a singular node in the ontological graph model. The relationships between the nodes in the knowledge graph may be maintained to be similar or same in the ontological graph model. For example, a triplet in knowledge graph including a node 501 (indicating “Forrest Gump”) and a node 504 (indicating “Tom Hanks”) that are tied with relationship C (indicating “has Cast”), may correspond to a triplet in the ontological graph model including a node 601 (indicating “Movie”) and a node 604 (indicating “Actor”) that are tied with relationship C’ (indicating “has Cast”). Although the nodes may have changed from specific values to a more general categorical values, the relationship between the respective nodes may be maintained.

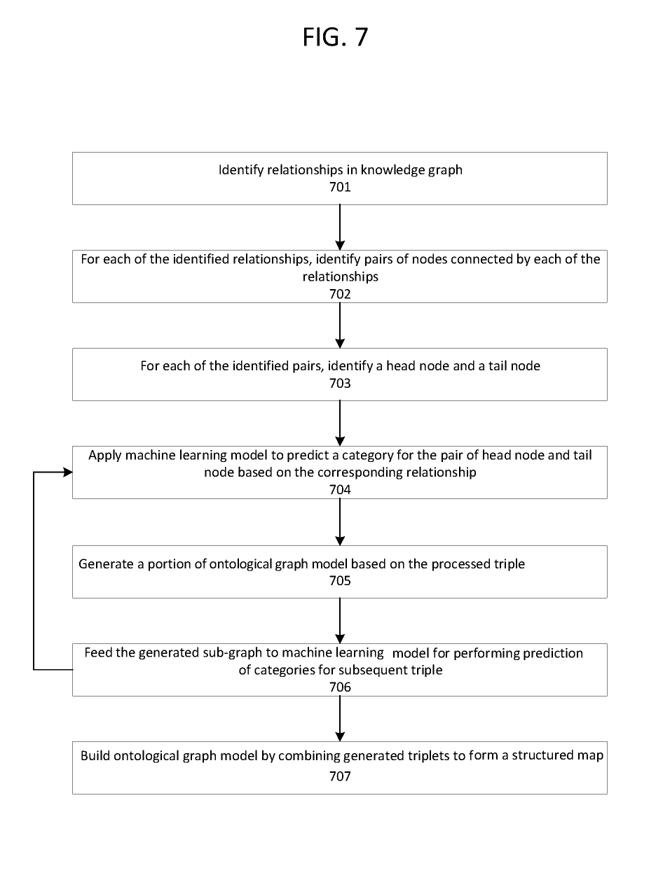

A more detailed description of the ontological graph model generation methodology is described with respect to FIG. 7 below.

In operation 405, one or more link predictions to be performed are determined. According to some aspects, link predictions may refer to a task of predicting missing links or future connections or links between entities in a knowledge graph. Link predictions may be performed to complete incomplete knowledge graphs by inferring missing relationships. However, aspects of the present disclosure are not limited thereto, such that the link predictions may also infer missing entities or attributes.

According to further aspects, one or more link predictions may be performed using one or more techniques, including heuristic methods, machine learning models, and embedding methods. However, aspects of the present disclosure are not limited thereto, such that other methods may be employed as appropriate. In an example, heuristic methods may be based on a graph topology, such as common neighbors. Machine learning models may utilize features derived from the knowledge graph or other graph topologies to train a predictive model. Embedding methos may represent entities and relationships in a continuous vector space to predict links.

According to some aspects, link predictions may include multiple types of predictions, including at least a transductive link prediction, an inductive link prediction and the like. Transductive link prediction may focus on predicting links within a fixed set of known entities. According to further aspects, the transductive link prediction may leverage the entirety of the knowledge graph structure.

In an example, in the transductive link prediction setting, there may be a set of entities, relationships and triplets. The known entities in this example may include “Forrest Gump”, “Tom Hanks”, “Paramount Pictures” and “United States”. The known relationships in this example may include “has cast”, “is produced by” and “is located in”. Lastly, the known triplets in this example may include a triplet of “Forrest Gump” → “has cast” → “Tom Hanks”, and another triplet of “Forrest Gump” → “is produced by” → “Paramount Pictures” Based on the above known information or data, the transductive link prediction may result in a prediction of a triplet “Tom Hanks” → “is located in” → “United States”.

On the other hand, inductive link prediction may aim to predict links involving new, previously unseen entities, which may involve a model to generalize from the training data to the new entities. According to some aspects, inductive link prediction may involve at least a two-step procedure, namely a training step and an inference. According to some aspects, the training may be performed to train a machine learning model using the knowledge graph. In an example, the training may be performed using the knowledge graph that was completed using the transductive link prediction. Once the machine learning model is trained using the knowledge graph, such learning model may be applied to a new set of entities or nodes with or without respect to existing entities to predict links or relationships between the new set of entities and/or relationships between new entities and existing entities.

In an example, in the inductive link prediction setting, there may be a set of entities, relationships and triplets. The known entities in this example may include “Forrest Gump”, “Tom Hanks”, “Paramount Pictures” and “United States”. The known relationships in this example may include “has cast”, “is produced by” and “is located in”. Lastly, the known triplets in this example may include a triplet of “Forrest Gump” → “has cast” → “Tom Hanks”, and another triplet of “Forrest Gump” → “is published by” → “Paramount pictures” Based on the above known information or data, the inductive link prediction may result in a prediction of a triplet involving a new entity “The Terminal” to provide “The Terminal” → “has cast” → “Tom Hanks”.

FIG. 7 illustrates a method for generating an ontological graph model using a knowledge graph using an LPLLM system in accordance with an embodiment.

According to some aspects, a generative ontological graph model may be created using one or more LLMs, which extracts structured knowledge directly from raw knowledge graph data. The generative ontological graph model may serve as a foundation for providing cues for inferring missing node categories and pathways between ontological graph model entities. In an example, in the inductive setting, the ontological graph model and category inference may be utilized to enhance missing node prediction. In the transductive setting, on the other hand, candidate solutions for triplets may be identified using the ontological graph model to predict the correction solution.

According to some aspects, O may represent an ontological graph model and G may represent a corresponding knowledge graph. Based on the above, O may be defined as O = (C, R, E), where C consists of ontological graph model nodes, node categories of the nodes in the knowledge graph, R may be the set and relations, and consists of unique triplets (cᵢ, r, cⱼ) where cᵢ, cⱼ ϵ C and r ϵ R. The knowledge graph G may be defined as G = (V, R, T), where V may refer to a set of nodes, where each node vᵢ ϵ V is associated with at least one category cvi ϵ C. R may refer to the set of relations, and T consists of triplets formed according to the ontological graph model triplets E. For nodes vᵢ of category cvi and vⱼ of category cvj , (vᵢ, r, vⱼ) ϵ T such that (cvi , r, cvj ) ϵ E.

In operation 701, known relationships in a knowledge graph are identified. With reference to FIG. 5, relationship A (indicating “releasedInYear”), relationship B (indicating “isFollowedBy”), relationship C (indicating “has Cast”), relationship D (indicating “isPublishedBy”), relationship E (indicating “has Cast”), relationship F (indicating “worksWith”), relationship G (indicating “isLocatedIn”), relationship H (indicating “isLocatedIn”) and relationship I (indicating “isLocatedIn”) may be identified.

In operation 702, for each of the identified relationships, pairs of nodes connected by each of the identified relationships are then identified. For example, relationship C (indicating “hasCast”) of FIG. 5 is connected by nodes 501 (indicating “Forrest Gump”) and 504 (indicating “Tom Hanks”).

In operation 703, for each of the identified pairs, a head node and a tail node are identified. With respect to FIG. 5, the head node may refer to a node from which the relationship or directional arrow originates from, and the tail node may refer to a node towards which the relationship or the directional arrow is directed. Depending on the triple, a node may either be a head node or a tail node. For example, node 505 may be a tail node in a triplet including nodes 504 and 505 connected by relationship F. However, node 505 may be a head node in a triplet including nodes 505 and 507 connected by relationship H.

In operation 704, a machine learning (ML) model or algorithm may be applied to predict a category for the pair of the head node and the tail node based on the corresponding relationship. For example, an LLM may be utilized for predicting the category for the pair of the head node and the tail node based on the corresponding relationship. Although the ML model or algorithm is referenced herein, other artificial intelligence (AI) algorithms or models may be utilized.

In an example, AI or ML algorithms may be generative, in that the AI or ML algorithms may be executed to perform data pattern detection, and to provide an output based on the data pattern detection. More specifically, an output may be provided based on a historical pattern of data, such that with more data or more recent data, more accurate outputs may be provided. Accordingly, the ML or AI models may be constantly updated after a predetermined number of runs or iterations are initially performed to provide initial training. According to some aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, N-fold cross-validation analysis, balanced class weight analysis, and the like. In another example embodiment, machine learning analytical techniques may include unsupervised learning algorithms such as, for example, Apriori analysis, K-means clustering analysis, etc. In another example embodiment, machine learning analytical techniques may include reinforcement learning algorithms such as, for example, Markov Decision Process analysis, and the like.

In another example embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another example embodiment, the ML or AI model may include training models such as, for example, a machine learning model which is generated to be further trained on additional data. Once the training model has been sufficiently trained, the training model may be deployed onto various connected systems to be utilized. In another example embodiment, the training model may be sufficiently trained when model assessment methods such as, for example, a holdout method, a K-fold-cross-validation method, and a bootstrap method determine that at least one of the training model’s least squares error rate, true positive rate, true negative rate, false positive rate, and false negative rates are within predetermined ranges.

In another example embodiment, the training model may be operable, i.e., actively utilized by an organization, while continuing to be trained using new data. In another example embodiment, the ML or AI models may be generated using at least one from among an artificial neural network technique, a decision tree technique, a support vector machines technique, a Bayesian network technique, and a genetic algorithms technique.

In operation 705, a portion of an ontological graph model may be generated based on the processed triple. For example, referring back to the triplet of (node 501, relationship C, node 504) in FIG. 5, relationship C may be retained as illustrated in FIG. 6. The node 601 (indicating a category of “Movie”) may be generated in the ontological graph model to correspond to node 501 (indicating “Forrest Gump”). Likewise, the node 604 (indicating a category of “Actor”) may be generated in the ontological graph model to correspond to node 504 (indicating “Tom Hanks”). As a result, the relationship C in the portion of the ontological graph model may now be connected to a node 601 (indicating a category of “Movie”) as the head node. Accordingly, the triplet in the knowledge graph may generate a triplet in the ontological graph model.

Although the above noted example resulted in a one-to-one conversion between the nodes in the knowledge graph and the generated ontological graph model, aspects of the present disclosure are not limited there to, such that multiple nodes in the knowledge graph may converge into a single node in the corresponding ontological graph model. For example, both the node 506 and node 507 may correspond to a category of “Location”. Accordingly, the node 506 (indicating “United States”) and node 507 (indicating “Hollywood”) in FIG. 5 may generate a singular node 606 (indicating a category of “Location”). As a result, triplet of the knowledge graph may be modified in the corresponding ontological graph model. More specifically, node 606 (indicating a category of “Location”) may server as a common tail node for both the node 604 (indicating a category of “Actor”) and the node 605 (indicating a category of “Production Co.”).

In operation 706, the generated sub-graph of the ontological graph model or a portion of the ontological graph model may be fed to the machine learning model for performing a prediction of categories for a subsequent triple. By performing the iterative generation approach that incorporates the previously created sub-graph at each step, consistency in the node class assignment may be ensured across similar nodes.

In operation 707, an ontological graph model may be generated by combining the generated triplets or sub-ontologies to form a structured map as exemplarily illustrated in FIG. 6.

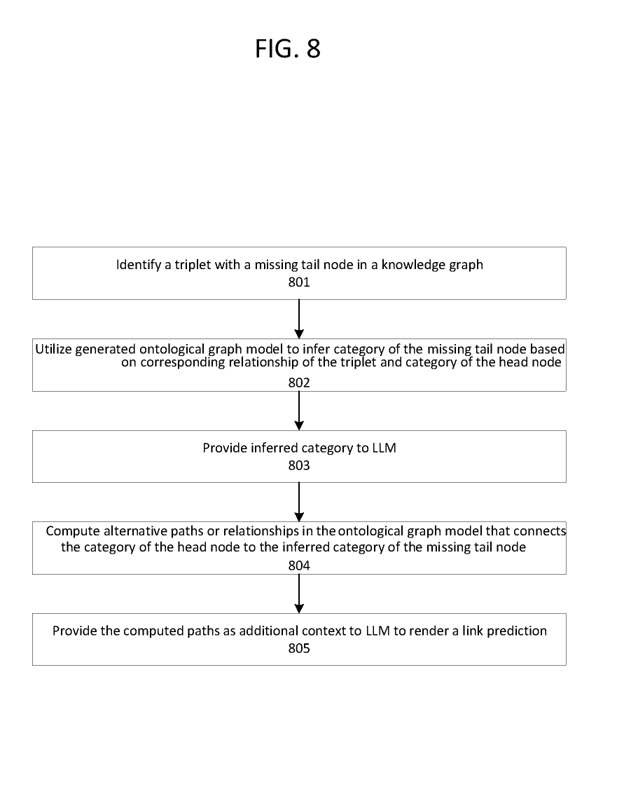

FIG. 8 illustrates a method for performing a link prediction using topology of a generated ontological graph model in accordance with an embodiment.

According to some aspects, knowledge graph completion may refer to a task of inferring missing information in a knowledge graph. For example, knowledge graph completion may include performing a node prediction. More specifically, knowledge graph completion may include predicting a missing tail entity or node vⱼ ε V given the head entity vᵢ ε V and the relation r ε R, i.e., (vᵢ, r, ?). However, aspects of the present disclosure are not limited thereto, such that the knowledge graph completion may include predicting a missing head entity or node.

In operation 801, a triplet with a missing tail node (or a missing head node) in a knowledge graph is identified. For example, the triplet with the missing tail node may include a triplet of (“Miles Davis”, “died in”, missing value).

In operation 802, generated ontological graph model is then utilized to infer a category of the missing tail node based on corresponding relationship of the triplet and category of the corresponding head node. In an example, the generated ontological graph model may include a triplet of (“musician” (head node), “died in” (relationship), “country” (tail node)). It may also be determined that the head node “Miles Davis” corresponds to a category of “musician”. Based on the category of the head node in the knowledge graph and the relationship that is common both in the knowledge graph and the ontological graph model, a machine learning model may infer that the missing node corresponds to a category of “country” based on the ontological graph model triplet. According to some aspects, the ontological graph model may be generated in accordance with the method illustrated in FIG. 7.

In operation 803, the inferred category of the missing node is then provided to the LLM to inform the LLM that the missing node should be a value corresponding to the category of “country”.

In operation 804, alternative paths in the ontological graph model that connects the category of the head node to the inferred category of the missing tail node. According to some aspects, the alternative paths may include another triplet or combination of triplets. For example, one alternative path may indicate a triplet of (“musician”, “part of band”, “band”) and “band” may belong to a triplet of (“band”, “conceived in country”, “country).

In operation 805, the computed alternative paths are provided as additional context to LLM to render a more accurate prediction. For example, the LLM will determine that the “country” that the “musician” has “died in” must be the same country that “band”, for which the “musician” was “part of”, was “conceived in”.

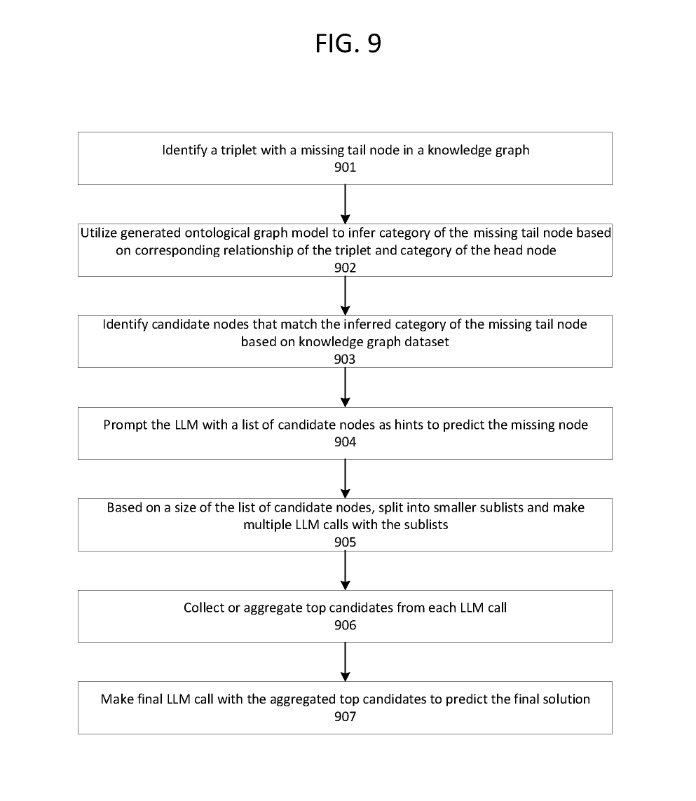

FIG. 9 illustrates a method for performing a link prediction using candidate solutions in accordance with an embodiment.

In operation 901, a triplet with a missing tail node (or a missing head node) in a knowledge graph is identified. For example, the triplet with the missing tail node may include a triplet of (“Miles Davis”, “died in”, missing value).

In operation 902, generated ontological graph model is then utilized to infer a category of the missing tail node based on corresponding relationship of the triplet and category of the corresponding head node. In an example, the generated ontological graph model may include a triplet of (“musician” (head node), “died in” (relationship), “country” (tail node)). It may also be determined that the head node “Miles Davis” corresponds to a category of “musician”. Based on the category of the head node in the knowledge graph and the relationship that is common both in the knowledge graph and the ontological graph model, a machine learning model may infer that the missing node corresponds to a category of “country” based on the ontological graph model triplet. According to some aspects, the ontological graph model may be generated in accordance with the method illustrated in FIG. 7.

In operation 903, candidate solutions may be created utilizing the knowledge graph dataset to find nodes that match the inferred category of the missing tail node. For example, all nodes in the knowledge graph that belong to the inferred category of “country” may be identified. However, aspects of the present disclosure are not limited thereto, such that the candidate solutions may be created utilizing training dataset.

In operation 904, LLM is provided with a list of candidate nodes as hints to predict the missing node.

In operation 905, the list of candidate nodes is split into smaller sublists and multiple LLM calls are made with the sublists. According to some aspects, a number of sublists may be based on the size of the list of candidate nodes.

In operation 906, top candidates from each LLM call are collected or aggregated. For example, if the LLM selects “USA” and “France” as top candidates from different sublists, these results may be aggregated.

In operation 907, a final LLM call is made with the aggregated top candidates to predict the ultimate solution. For example, LLM may be provided with the final list of top candidates (“USA”, “France”) to determine the most likely place where “Miles Davis” died.

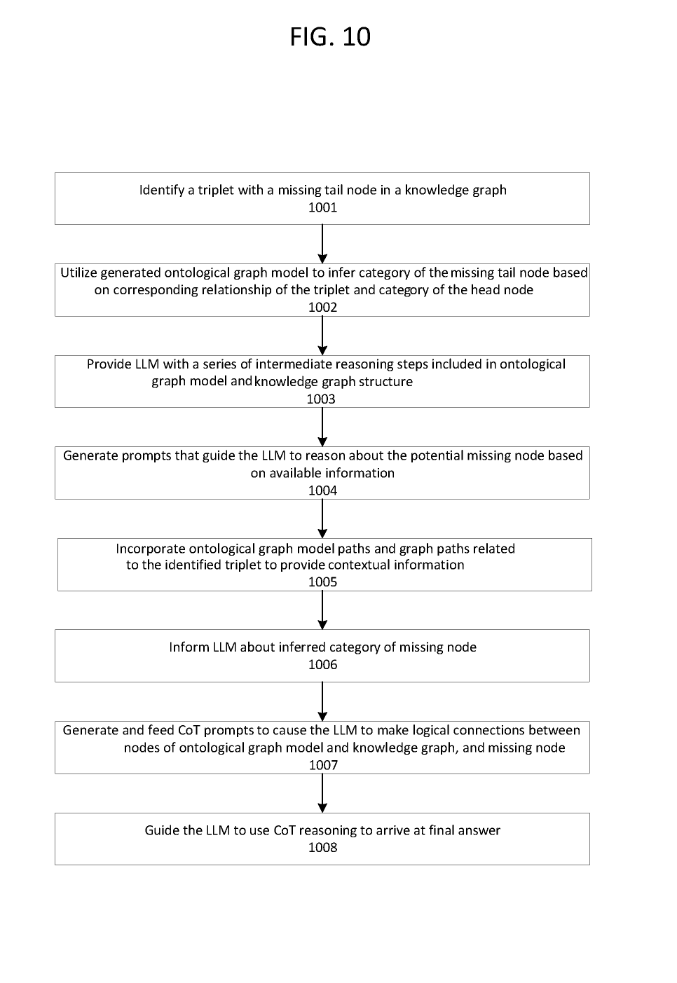

FIG. 10 illustrates a link prediction performed by an LPLLM system on an incomplete knowledge graph in accordance with an embodiment.

In operation 1001, a triplet with a missing tail node (or a missing head node) in a knowledge graph is identified. For example, the triplet with the missing tail node may include a triplet of (“Miles Davis”, “died in”, missing value).

In operation 1002, generated ontological graph model is then utilized to infer a category of the missing tail node based on corresponding relationship of the triplet and category of the corresponding head node. In an example, the generated ontological graph model may include a triplet of (“musician” (head node), “died in” (relationship), “country” (tail node)). It may also be determined that the head node “Miles Davis” corresponds to a category of “musician”. Based on the category of the head node in the knowledge graph and the relationship that is common both in the knowledge graph and the ontological graph model, a machine learning model may infer that the missing node corresponds to a category of “country” based on the ontological graph model triplet. According to some aspects, the ontological graph model may be generated in accordance with the method illustrated in FIG. 7.

In operation 1003, LLM is provided with a series of intermediate reasoning steps based on the generated ontological graph model and structure of the knowledge graph. For example, the LLM may be asked to consider relevant information from the ontological graph model and the knowledge graph structure.

In operation 1004, prompts that guide the LLM to reason about the potential missing node are generated based on available information. For example, a prompt of “what type of entity is ‘Miles Davis’?” may be provided to the LLM, for which LLM may answer as “Musician” by referring to the ontological graph model and the knowledge graph structure. In another example, a prompt of “what type of place do musicians typically die in?” may be provided to the LLM, for which LLM may answer as “Country” by referring to the ontological graph model and the knowledge graph structure.

In operation 1005, ontological graph model paths and knowledge graph paths related to the given triplet with the missing node may be utilized to provide context. For example, ontological graph model paths of “musician” (node) → “part of band” (relationship) → “band” (node) → “conceived in country” (relationship) → “country” (node) may be provided as context to inform the LLM that the “country” that the “musician” has “died in” must be the same country that “band”, for which the “musician” was “part of”, was “conceived in”.

In operation 1006, inferred category of the missing node is provided to the LLM. For example, LLM may be told that the category of the missing node is “country”.

In operation 1007, chain-of-though (CoT) prompts utilized to make logical connections between available information and the missing node. More specifically, the CoT prompts may be generated and fed to the LLM based on the contextual information and the inferred category of the missing node. Additionally, based on the CoT prompts, the LLM may be caused to make logical connections between nodes included in the ontological graph model and the knowledge graph, and the missing tail node and the inferred category of the missing tail node.

According to some aspects, CoT prompting may refer to a procedure that allows LLMs to perform complex reasoning tasks by breaking down the problem into a series of intermediate steps. In other words, LLM may be provided with a roadmap to follow (e.g., ontological graph model paths and knowledge paths) to follow instead of just the destination. CoT prompting may provide transparent reasoning process of the LLM more transparent, allowing users to understand how the LLM arrived at the ultimate solution. Such transparency may allow users to identify any potential bias or errors.

According to some aspects, the CoT prompts may be automatically generated based on the ontological graph model paths and/or knowledge paths. For example, a CoT prompt may state that “given that ‘Miles Davis’ is a musician, and musicians die in countries, what country could ‘Miles Davis” have died in?”.

In operation 1008, LLM may be guided to use the CoT reasoning to arrive at the final answer.

Although the invention has been described with reference to several example embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, example embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing a link prediction of a missing node in a knowledge graph using a large language model (LLM) without prior training for the knowledge graph, the method comprising:
acquiring, by a processor and over a communication network, the knowledge graph;
extracting, by the processor, a set of information from the knowledge graph, wherein the set of information indicates a plurality of data entities, a plurality of edges, and attributes for one or more of the plurality of data entities, wherein each of the plurality of edges indicates a relationship between a pair of data entities among the plurality of data entities, and wherein each of the data entities corresponds to a node on the knowledge graph;
identifying, by the processor, a plurality of triplets included in the knowledge graph based on the extracted set of information, wherein each of the plurality of triplets includes a pair of nodes connected by an edge, and wherein the plurality of triplets includes at least one triplet with a missing node;
generating, by the processor, an ontological graph model based on the plurality of triplets identified and the acquired knowledge graph, wherein the ontological graph model includes a plurality of triplets, wherein each of the plurality of triplets includes a pair of nodes connected by an edge, wherein each of the nodes corresponds to a category of a data entity; and
performing, via the LLM, a link prediction for the missing node of the knowledge graph based on the generated ontological graph model,
wherein the link prediction using the ontological graph model includes:
identifying, by the processor, an incomplete triplet including a missing tail node from the knowledge graph;
inferring, via a machine learning model, a category of the missing tail node using the generated ontological graph model and based on an edge included in the incomplete triplet and a category of a head node included in the incomplete triplet;
providing, to the LLM, the inferred category of the missing tail node;
computing, by the processor, alternative ontological graph model paths from the head node of the incomplete triplet to the missing tail node of the incomplete triplet;
providing, to the LLM, the computed alternative ontological graph model paths as contextual information; and
performing, by the LLM, the link prediction based on the contextual information.

2. The method according to claim 1, wherein the pair of nodes of the ontological graph model includes a head node from which the edge flows and a tail node to which the edge is directed.

3. The method according to claim 2, wherein the missing node of knowledge graph corresponds to the tail node of the ontological graph model.

4. The method according to claim 1, wherein the generating of the ontological graph model includes:
identifying, by the processor, the plurality of edges included in the knowledge graph;
for each of the plurality of edges identified, identifying, by the processor, a pair of nodes of the knowledge graph connected by a corresponding edge, the pair of nodes of the knowledge graph and the corresponding edge forming a triplet among the plurality of triplets;
for each of the pair of nodes of the knowledge graph, identifying, by the processor, a head node and a tail node;
predicting, by applying the machine learning model executed by the processor, a category for the head node of the knowledge graph and a category of the tail node of the knowledge graph based on a corresponding edge among the plurality of edges;
generating a portion of the ontological graph model by forming a target triplet including the category for the head node of the knowledge graph and the category of the tail node of the knowledge graph connected by the corresponding edge; and
building, by the processor, the ontological graph model by using the target triplet.

5. The method according to claim 4, wherein the ontological graph model is formed of the plurality of triplets including the target triplet including the category for the head node of the knowledge graph and the category of the tail node of the knowledge graph connected by the corresponding edge.

6. The method according to claim 1, wherein the LLM is given an option to re-use a previously predicted category.

7. The method according to claim 1, wherein the generating of the ontological graph model further includes:
assigning, by the machine learning model, synonyms for each of the category for the head node and the category of the tail node.

8. The method according to claim 4, wherein the generating of the ontological graph model further includes:
feeding the generated portion of the ontological graph model to the machine learning model for performing a prediction of categories for another triplet that is to be added to the ontological graph model.

9. The method according to claim 1, wherein the link prediction is performed using a topology of the ontological graph model.

10. The method according to claim 1, wherein at least one of the alternative ontological graph model paths includes at least two triplets that are connected.

11. The method according to claim 1, wherein the link prediction is performed using candidate solutions, and
wherein the link prediction using the candidate solutions includes:
identifying, by the processor, an incomplete triplet including a missing head/tail node from the knowledge graph;
inferring, via the machine learning model, a category of the missing head/tail node using the generated ontological graph model and based on the edge included in the incomplete triplet and a category of a head node included in the incomplete triplet;
identifying, via the machine learning model, candidate nodes that match the inferred category of the missing head/tail node based on dataset of the knowledge graph; and
prompting, the LLM, with a list of the candidate nodes as a hint for predicting the missing head/tail node.

12. The method according to claim 11, wherein the link prediction using the candidate solutions further includes:
splitting, by the processor, the list of the candidate nodes into a plurality of sublists;
performing a plurality of LLM calls to the LLM with the plurality of sublists;
collecting, by the processor, a top candidate from each of the plurality of sublists based on the plurality of LLM calls; and
performing a subsequent LLM call to the LLM with the collected top candidates to predict a single solution for the missing head/tail node among the collected top candidates.

13. The method according to claim 1, wherein the link prediction is performed using a chain-of-thought (CoT) reasoning, and
wherein the link prediction using the CoT reasoning includes:
identifying, by the processor, an incomplete triplet including a missing head/tail node from the knowledge graph;
inferring, via the machine learning model, a category of the missing head/tail node using the generated ontological graph model and based on the edge included in the incomplete triplet and a category of a head node included in the incomplete triplet;
providing the LLM with a series of intermediate reasoning steps included in the ontological graph model and knowledge graph structure;
generating a plurality of prompts that guide the LLM to perform a step-by-step reasoning to derive a solution for the missing head/tail node;
incorporating a plurality of ontological graph model paths and a plurality of knowledge graph paths to the identified missing head/tail node to provide contextual information;
informing the LLM of the inferred category of the missing head/tail node;
generating and feeding a series of prompts, based on the contextual information and the inferred category of the missing node, to cause the LLM to make logical connections between nodes included in the ontological graph model and the knowledge graph, and the missing head/tail node and the inferred category of the missing head/tail node; and
generating, by the LLM, a solution for the missing head/tail node based on the series of prompts.

14. The method according to claim 1, wherein the link prediction is a transductive link prediction that predicts an edge among known entities within the knowledge graph.

15. The method according to claim 1, wherein the link prediction is an inductive link prediction that predicts an edge of a new entity with respect to known entities within the knowledge graph.

16. The method according to claim 1, wherein the edges in the knowledge graph are same as the edges in the ontological graph model.

17. The method according to claim 1, wherein the ontological graph model includes a plurality of paths from a head node to a tail node of a respective triplet.

18. The method according to claim 17, wherein the LLM is automatically prompted based on the plurality of paths and structural information of the knowledge graph.

19. A system for performing a link prediction of a missing node in a knowledge graph using a large language model (LLM) without prior training for the knowledge graph, the system comprising:
a processor; and
a memory operatively connected to the processor via a communication interface, the memory storing computer readable instructions, when executed, causes the processor to:
acquiring, over a communication network, the knowledge graph;
extracting a set of information from the knowledge graph, wherein the set of information indicates a plurality of data entities, a plurality of edges, and attributes for one or more of the plurality of data entities, wherein each of the plurality of edges indicates a relationship between a pair of data entities among the plurality of data entities, and wherein each of the data entities corresponds to a node on the knowledge graph;
identifying a plurality of triplets included in the knowledge graph based on the extracted set of information, wherein each of the plurality of triplets includes a pair of nodes connected by an edge, and wherein the plurality of triplets includes at least one triplet with a missing node;
generating an ontological graph model based on the plurality of triplets identified and the acquired knowledge graph, wherein the ontological graph model includes a plurality of triplets, wherein each of the plurality of triplets includes a pair of nodes connected by an edge, wherein each of the nodes corresponds to a category of a data entity; and
performing, via the LLM, a link prediction for the missing node of the knowledge graph based on the generated ontological graph model,
wherein the link prediction using the ontological graph model includes:
identifying an incomplete triplet including a missing tail node from the knowledge graph;
inferring, via a machine learning model, a category of the missing tail node using the generated ontological graph model and based on an edge included in the incomplete triplet and a category of a head node included in the incomplete triplet;
providing, to the LLM, the inferred category of the missing tail node;
computing alternative ontological graph model paths from the head node of the incomplete triplet to the missing tail node of the incomplete triplet;
providing, to the LLM, the computed alternative ontological graph model paths as contextual information; and
performing, by the LLM, the link prediction based on the contextual information.

20. A non-transitory computer readable medium configured to store instructions for performing a link prediction of a missing node in a knowledge graph using a large language model (LLM) without prior training for the knowledge graph, the instructions, when executed, cause a processor to perform the following:
acquiring, over a communication network, the knowledge graph;
extracting a set of information from the knowledge graph, wherein the set of information indicates a plurality of data entities, a plurality of edges, and attributes for one or more of the plurality of data entities, wherein each of the plurality of edges indicates a relationship between a pair of data entities among the plurality of data entities, and wherein each of the data entities corresponds to a node on the knowledge graph;
identifying a plurality of triplets included in the knowledge graph based on the extracted set of information, wherein each of the plurality of triplets includes a pair of nodes connected by an edge, and wherein the plurality of triplets includes at least one triplet with a missing node;
generating an ontological graph model based on the plurality of triplets identified and the acquired knowledge graph, wherein the ontological graph model includes a plurality of triplets, wherein each of the plurality of triplets includes a pair of nodes connected by an edge, wherein each of the nodes corresponds to a category of a data entity; and
performing, via the LLM, a link prediction for the missing node of the knowledge graph based on the generated ontological graph model,
wherein the link prediction using the ontological graph model includes:
identifying an incomplete triplet including a missing tail node from the knowledge graph;
inferring, via a machine learning model, a category of the missing tail node using the generated ontological graph model and based on an edge included in the incomplete triplet and a category of a head node included in the incomplete triplet;
providing, to the LLM, the inferred category of the missing tail node;
computing alternative ontological graph model paths from the head node of the incomplete triplet to the missing tail node of the incomplete triplet;
providing, to the LLM, the computed alternative ontological graph model paths as contextual information; and
performing, by the LLM, the link prediction based on the contextual information.
